(19) United States
(12) Patent Application Publication
(10) Pub. No.: US 2010/0005317 A1
(43) Pub. Date: Jan. 7, 2010

(54) Securing temporary data stored in non-volatile memory using volatile memory

(75) Inventors: Kris Pribadi, Dollard des Ormeaux (CA); Laurence Hamid, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: Memory Experts International Inc., Montreal (CA)

(21) Appl. No.: 12/216,290

(22) Filed: Jul. 2, 2008

Related U.S. Application Data
(60) Provisional application No. 60/929,754, filed on Jul. 11, 2007.

(51) Int. Cl. G06F 12/14; H04L 9/06; H04L 9/14

(52) U.S. Cl. 713/193; 380/277; 380/44

(57) ABSTRACT

Temporary digital data received for storage in non-volatile memory are encoded using a key stored in volatile memory. The encoded digital data are then stored in the non-volatile memory. As long as there has been no interruption of supply of power to the volatile memory, the key is available enabling decoding of the encoded digital data stored in the non-volatile memory. Upon interruption of supply of power to the volatile memory the key is erased. Absent the key, access to the encoded digital data stored in the non-volatile memory is prevented.

This application claims the benefit of U.S. Provisional Application No. 60/929,754 filed on Jul. 11, 2007, the entire content of which is incorporated herein by reference.

### FIELD OF THE INVENTION

The instant invention relates to the field of computer security and in particular to a method and system for securely storing temporary data stored in non-volatile memory.

### BACKGROUND OF THE INVENTION

Information theft has become a major concern for every organization. A misconception shared by many is that printers, copiers, and fax machines are benign office machines and no more of a security threat than a mechanical typewriter. A recent survey of IT professionals revealed that 47% believed that copiers and printers didn't contain non-volatile memory such as a hard drive. Additionally, 65% believed that copiers and printers presented little or no risk to data security.

Since non-volatile memory such as disk-storage is substantially cheaper for data volumes than volatile memory such as RAM, modern copiers, printers, and fax machines often contain non-volatile memory in the form of hard drives similar to those found in workstations, personal computers, and laptops. These devices automatically store on the hard drive any digital data that are received or generated for printing, copying, or faxing, i.e. they often contain sensitive data on the hard drive resulting in an often overlooked security risk. The stored data are easily accessed by removing the hard drive from the device, for example, during maintenance or when the device is powered down, and connecting the hard drive to a computer. In high security areas, for example, military installations, there is often a requirement that all data stored in non-volatile memory such as a hard drive be inaccessible. To fulfill this requirement, security personnel must remove each hard drive from each common area device after power-down, store the same in a secure location such as a safe, and reinstall the same prior to power-up of the devices. As is evident, this is an expensive and inefficient routine for securing data.

Another security risk of non-volatile memory is that even when data have been “erased,” it is still possible to recover and read the data. For example, data are recovered because only a directory entry or a pointer to the data is often erased in erasing of data, because data compression or multi-bit coding techniques do not overwrite a substantial portion of the data, or because techniques exist for detecting residual elements of a magnetic pattern remaining on the disk after an overwrite has been used.

It would be beneficial to overcome the drawbacks of the present technology and to increase data security in devices such as printers, copiers, and fax machines.

### SUMMARY OF THE INVENTION

It is, therefore, an object of aspects of the invention to provide a method and system for securing temporary data stored in non-volatile memory.

In accordance with an aspect of the present invention there is provided a method comprising: providing a device comprising a non-volatile memory; receiving digital data for being stored in the non-volatile memory; prior to storing the digital data in the non-volatile memory, encoding the digital data using a key stored in a volatile memory that is supplied with power only when the device is in a powered-on condition, the volatile memory for being erased automatically upon interruption of supply of power thereto, the encoding for preventing access to the digital data in a non-encoded form absent the key; storing the encoded digital data in the non-volatile memory; and, subsequent to storing the encoded digital data in the non-volatile memory, erasing the key from the volatile memory.

In accordance with an aspect of the present invention there is provided a system comprising: volatile memory for storing a key therein, the volatile memory for being erased upon interruption of supply of power thereto; a communication and output port; circuitry connected to the communication and output port, to the volatile memory and for being connected to non-volatile memory of a device, the circuitry for: receiving temporary digital data for storage in the non-volatile memory of the device; encoding the temporary digital data using the key stored in the volatile memory, the encoding for preventing access to the encoded temporary digital data absent the key, the key other than stored within non-volatile memory of the device; providing the encoded temporary digital data for storage in the non-volatile memory; retrieving the encoded temporary digital data from the non-volatile memory; decoding the retrieved encoded temporary digital data using the key stored in the volatile memory; and, providing the temporary digital data.

In accordance with an aspect of the present invention there is provided a computer readable storage medium having stored thereon executable commands for execution on a processor, the processor when executing the commands performing: one of generating a key and receiving a key for use in encoding; storing the key in volatile memory; receiving digital data for storage in non-volatile memory of a device; encoding the digital data using the key stored in the volatile memory, the encoding for preventing access to the encoded digital data in a non-encoded form absent the key, the key other than stored within non-volatile memory of the device; providing the encoded digital data for storage in the non-volatile memory; retrieving the encoded digital data from the non-volatile memory; decoding the retrieved encoded digital data using the key stored in the volatile memory; and, providing the digital data.

In accordance with an aspect of the present invention there is provided a method comprising: providing a device for processing digital data and comprising a queue, the queue comprising non-volatile memory; receiving digital data for being stored within the queue and processed by the device; ciphering the received digital data with a key to provide secure data, the key stored in volatile memory and for being erased when at least one of power is other than provided to the volatile memory and the received digital data has been ciphered; storing the secure data within the queue; retrieving the secure data from the queue; deciphering the secure data using the key stored in volatile memory; and processing the deciphered secure data.

### BRIEF DESCRIPTION OF THE DRAWINGS

Exemplary embodiments of the invention will now be described in conjunction with the following drawings, in which:

FIG. 1a is a simplified flow diagram of a method for securing data stored in non-volatile memory according to an embodiment of the instant invention;

FIG. 1b is a simplified flow diagram of a method for securing data stored in non-volatile memory according to an embodiment of the instant invention;

FIG. 2a is a simplified block diagram of a system according to an embodiment of the instant invention for implementing the methods shown in FIGS. 1a and 1b;

FIG. 2b is a simplified block diagram of a system according to an embodiment of the instant invention for implementing the methods shown in FIGS. 1a and 1b;

FIG. 2c is a simplified block diagram of a system according to an embodiment of the instant invention for implementing the methods shown in FIGS. 1a and 1b; and,

FIG. 2d is a simplified block diagram of a system according to an embodiment of the instant invention for implementing the methods shown in FIGS. 1a and 1b.

### DETAILED DESCRIPTION OF THE DRAWINGS

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

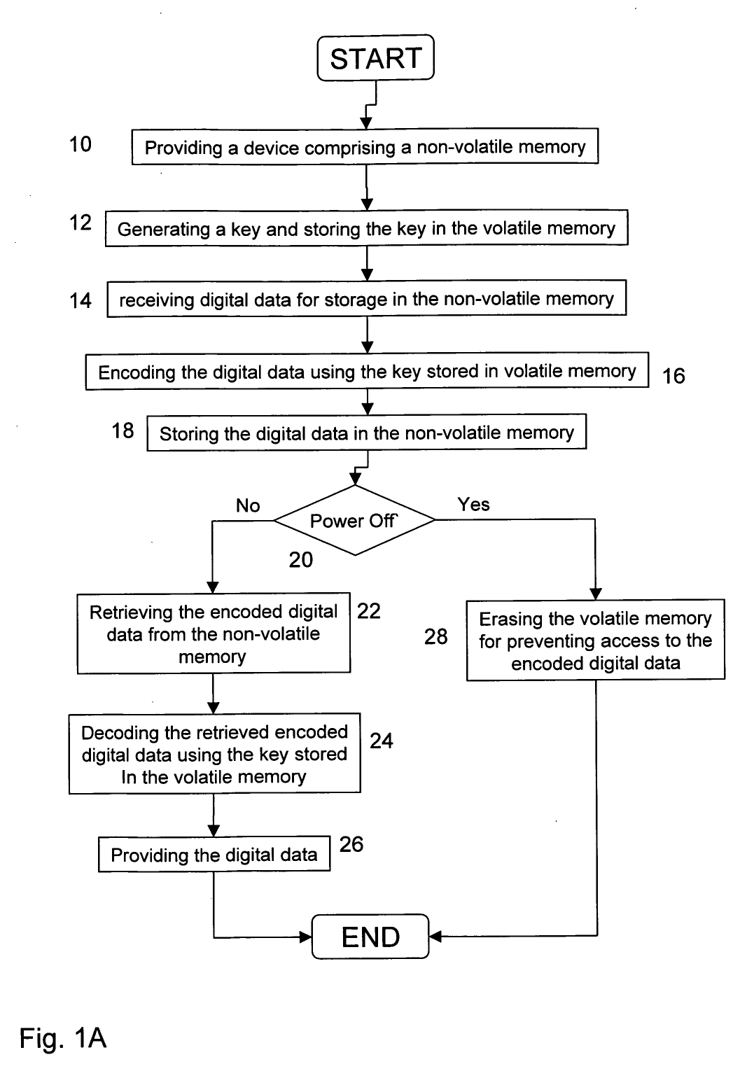

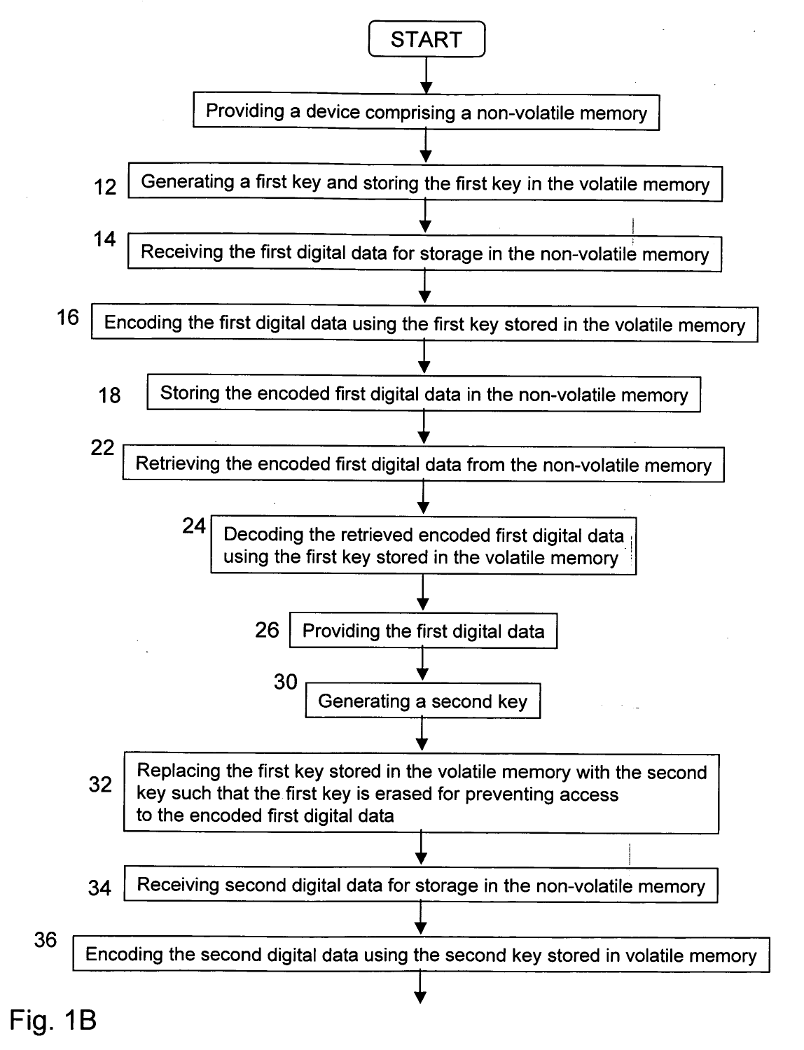

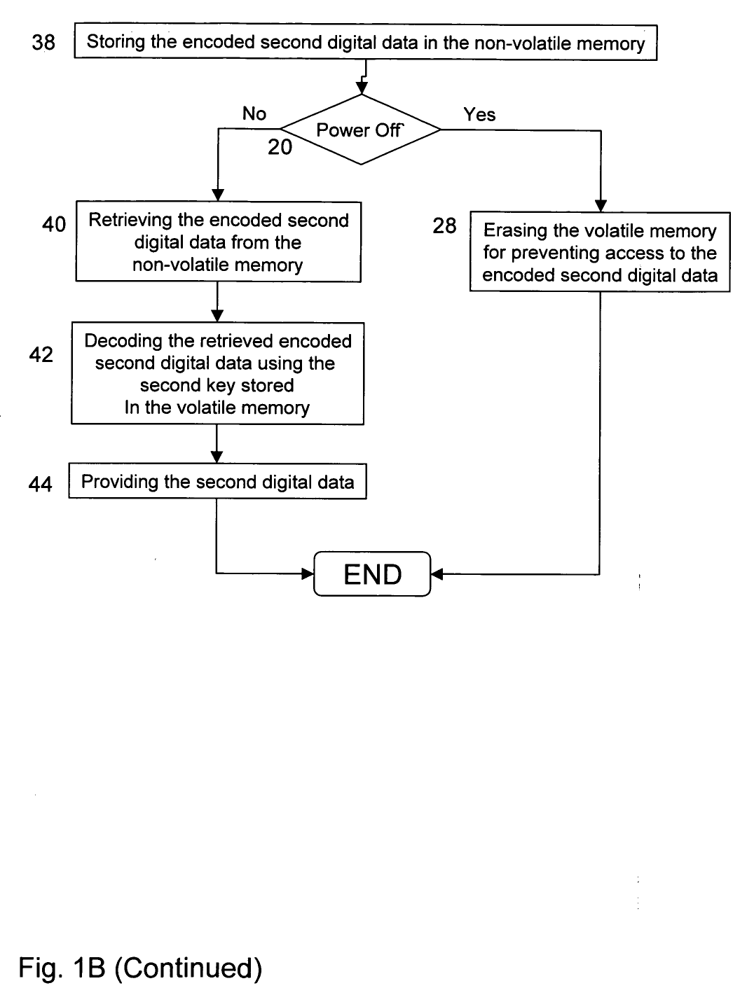

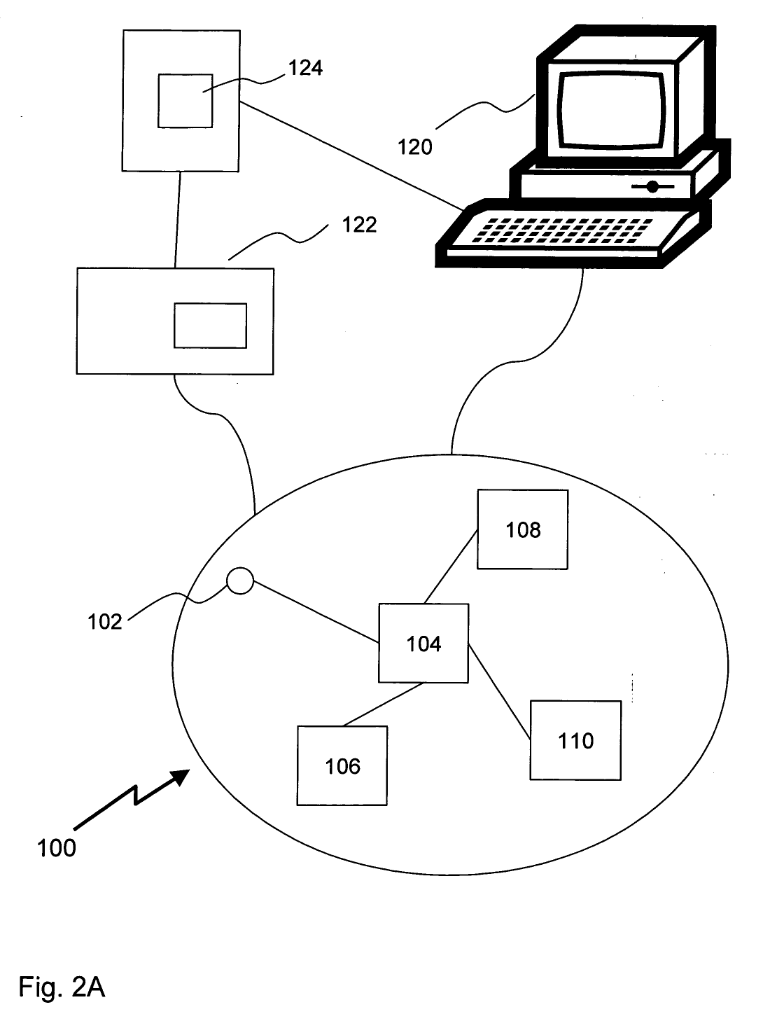

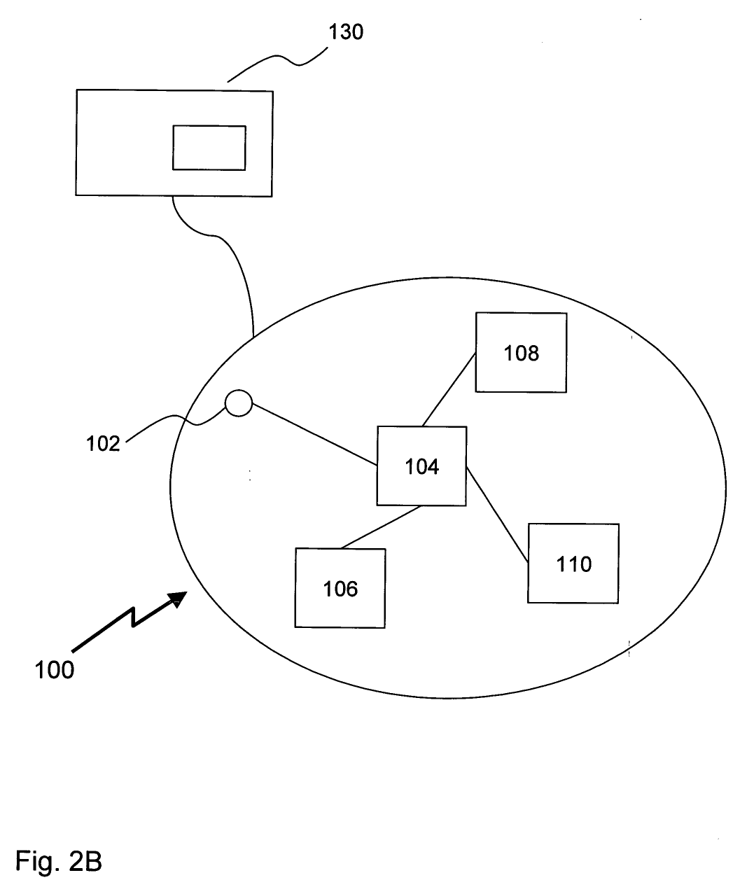

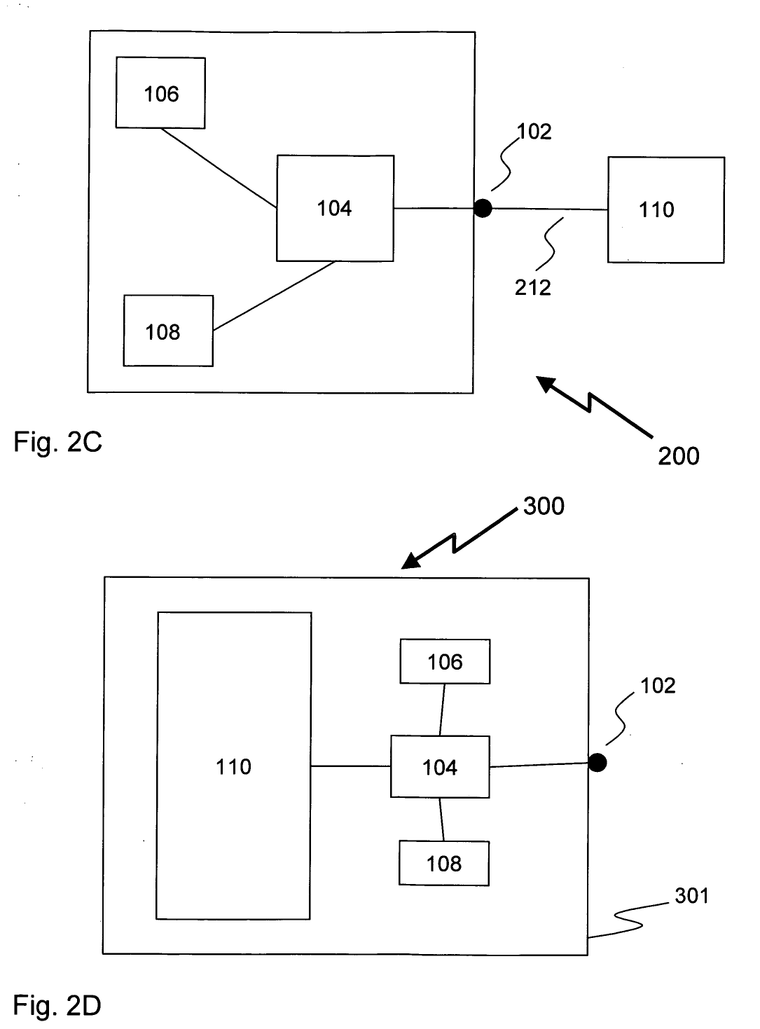

Referring to FIG. 1a, shown is a simplified flow diagram of a method for securing data stored in non-volatile memory, according to an embodiment of the instant invention. For the sake of clarity, the method is described in connection with system 100, shown in FIGS. 2a and 2b, for its implementation. For example, in a corporate network such as a Local Area Network (LAN), devices 120 and 122 comprising non-volatile memory 110 such as a hard drive are provided—10—and connected to a server 124, as shown in FIG. 2a. The devices 120 and 122 comprise, for example, workstations, printers, copiers, and, fax machines. As will become evident, the method and system for securing data stored in non-volatile memory is also implementable in device 130 provided—at 10—for independent operation, as shown in FIG. 2b, such as, for example, a copier or fax machine comprising non-volatile memory for storing data for printing multiple copies or sending multiple faxes. Alternatively, the method is implemented using one of systems 200 and 300 of FIGS. 2c and 2d, respectively.

At 12, a key is generated using, for example, processor 104 executing commands stored in memory 108 and is then stored in volatile memory 106, for example, Random Access Memory (RAM) of the processor 104. Encoding data using, for example, a cipher or encryption key and generation of the same is well known in the art and there are numerous encryption processes applicable. Depending on: the processing capability available; the digital data to be encoded; and, the security level to be ensured, one of skill in the art will readily select a suitable encryption process such as, for example, one of the symmetric encryption processes—Twofish, Serpent, AES, Blowfish, CAST5, RC4, TDES, and IDEA—to name a few. Alternatively, the key is generated outside the system 100, for example, using a trusted entity 125 installed in the server 124 or a key service provider connected to the server, transmitted to the device 120, 122 and received at port 102. Upon receipt, the key is then stored in the volatile memory 106.

At 14, digital data are received for storage, for example in a queue in the non-volatile memory 110. The received digital data are, for example, temporary digital data such as cache data or buffer data and are, for example, allocated to a temporary file directory. For example, temporary digital data are stored in non-volatile memory in the printer—received digital data for printing multiple copies; in the copier—digital data generated by scanning a document for printing multiple copies; in the fax machine—received digital data or digital data generated by scanning a document for sending multiple faxes; and in the workstation—temporary files of various applications for document recovery and temporary internet files for multiple access of a same website, to name but a few non-limiting examples. Upon receipt, using the processor 104, the digital data are encoded using the key stored in the volatile memory 106—at 16—in order to secure the same. The encoded digital data are then stored in the non-volatile memory 110—at 18.

As long as there has been no interruption of supply of power—at 20—to the volatile memory 106, the key is available enabling decoding the encoded digital data. For example, upon receipt of a request the processor 104 retrieves the encoded digital data from the non-volatile memory 110—at 22—decodes the retrieved encoded digital data using the key stored in the volatile memory 106—at 24—and provides the decoded digital data—at 26, for example, for printing multiple copies.

Upon interruption of supply of power to the volatile memory 106—at 20—data within the volatile memory 106—i.e. the key—is erased—at 28. Absent the key, access to the encoded digital data stored in the non-volatile memory 110 is prevented. For example, the volatile memory 106 is erased upon power-down of the device 120, 122, 130. This provides a simple solution for securing temporary data stored in non-volatile memory without user intervention, i.e. when the device 120, 122, 130 is powered-down, for example, after office hours or for maintenance, access to the digital data stored in the non-volatile memory is automatically prevented. Accordingly, removing the non-volatile memory from the device 120, 122, 130 and retrieving the encoded digital data is futile. As is evident, techniques for detecting residual elements of a magnetic pattern remaining on the disk are also not useful in accessing the digital data for the same reason.

Optionally, the processor 104 also interrupts the power supply to the volatile memory 106 prior to switching of the device 120, 122, 130 into one of a stand-by mode and hibernation mode. Erasing the key prior to switching into the one of a stand-by mode and hibernation mode is beneficial in situations where the device 120, 122, 130 is used by numerous users, for example, a central copier in an office. For example, a dishonest employee is then prevented from printing documents belonging to colleagues at times, for example during lunch break, when the copier is not used but still powered-on.

Referring to FIG. 1b, shown is a simplified flow diagram of a method for securing data stored in non-volatile memory, according to an embodiment of the instant invention. As above, the method is described in connection with system 100, shown in FIGS. 2a and 2b, for its implementation. Alternatively, the method is implemented using one of systems 200 and 300 of FIGS. 2c and 2d, respectively. For the sake of clarity, same reference numerals are used for same method steps disclosed above.

During a first time period the method for securing data stored in non-volatile memory that is shown in FIG. 1b is the same as described above for FIG. 1a—steps 10 to 18 and steps 22 to 26—securing temporary data by encoding the same using a first key. After elapse of a predetermined time interval a second key is generated—at 30. The first key stored in the volatile memory 106 is then replaced—at 32—with the second key such that the first key is erased for preventing access to the digital data encoded using the first key, for example, by storing the second key at the storage location of the first key in the volatile memory 106. For example the predetermined time interval relates to a period of time wherein no temporary data is queued within the device.

At 34, second digital data are received for storage in the non-volatile memory 110. Upon receipt, using the processor 104, the second digital data are encoded using the second key stored in the volatile memory 106—at 36. The encoded second digital data are then stored in the non-volatile memory 110—at 38. As long as there has been no interruption of supply of power—at 20—to the volatile memory 106, the second key is available enabling decoding of the encoded digital data. For example, upon receipt of a request the processor 104 retrieves the encoded second digital data from the non-volatile memory 110—at 40—decodes the retrieved encoded second digital data using the second key stored in the volatile memory 106—at 42—and provides the decoded digital data—at 44, for example, for printing multiple copies.

Upon interruption of supply of power to the volatile memory 106—at 20—data within the volatile memory 106—i.e. the key—is erased—at 28. Absent the key, access to the encoded second digital data stored in the non-volatile memory 110 is prevented. For example, the volatile memory 106 is erased upon power-down of the device 120, 122, 130.

Of course, it is possible to repeat the steps 30 to 44 numerous times, i.e. generating a new key after either a further predetermined time interval has elapsed or a predetermined event has occurred, and using the new key for encoding the received digital data, until the device 120, 122, 130 is powered-down.

For example, a new key is generated after predetermined time intervals; after completion of an application executed on the device—for example, after a web browser application is closed, access to the temporary internet files stored during this session is prevented by generating a new key; during a logoff process; and during a process for switching the device into one of a stand-by mode and hibernation mode. Alternatively, a new key is generated in dependence upon a state of the temporary data store and the future usefulness of data therein for its intended purpose. For example, an empty print queue prompts generation of a new key.

The above methods for securing data stored in non-volatile memory are implementable using the system 100 shown in FIGS. 2a and 2b. As shown in FIGS. 2a and 2b, the system 100 comprises the processor 104 connected to the communication and output port 102, for example, a Universal Serial Bus (USB) port or an Advanced Technology Attachment (ATA) port such as an Integrated Drive Electronics (IDE) port, the volatile memory 106, for example, RAM of the processor 104, the memory 108, and the non-volatile memory 110. The processor 104 generates or receives the key; stores the key in the volatile memory 106; encodes the received digital data using the key and stores the encoded digital data in the non-volatile memory 110; retrieves the encoded digital data and decodes the retrieved encoded digital data using the key stored in the volatile memory 106. The processor 104 performs the method by executing executable commands stored in the memory 108. Alternatively, the processor 104 comprises electronic circuitry designed for performing the method in a hardware implemented fashion, thus allowing omission of the memory 108. Optionally, the method for securing data stored in non-volatile memory is implemented using the processor and volatile memory of the device by providing executable commands stored in a storage medium for execution on the processor, for example, for implementation on a workstation.

Alternatively, in the system 200 that is shown in FIG. 2c the processor 104, the volatile memory 106, and the memory 108 are disposed, for example, on a Printed Circuit Board (PCB) which is inserted into an expansion slot of the device, for example, a workstation, and connected to the non-volatile memory 110 of the device via bus system 212 connected to the communication and output port 102, for example, a Universal Serial Bus (USB) port or an Advanced Technology Attachment (ATA) port such as an Integrated Drive Electronics (IDE) port. Optionally, the processor 104 comprises electronic circuitry designed for performing the method in a hardware-implemented fashion, and RAM of the processor is used for storing the key. This enables implementation of the above method for securing data stored in non-volatile memory by providing a single chip, for example, a Field Programmable Gate Array (FPGA) for insertion into an appropriate socket of the device.

Further alternatively, as shown in the system 300 according to the invention of FIG. 2d, the processor 104, the volatile memory 106, the memory 108, and the non-volatile memory 110 are disposed within a single housing 301 and are connected to, for example, a bus system of the device via the communication and output port 102, for example, a Universal Serial Bus (USB) port or an Advanced Technology Attachment (ATA) port such as an Integrated Drive Electronics (IDE) port. Optionally, the processor 104 comprises electronic circuitry designed for performing the method in a hardware-implemented fashion, and RAM of the processor is used for storing the key.

As is evident, the systems shown in FIGS. 2a to 2d are implementable as a retrofit in existing devices, for example, by providing executable commands for execution on a processor of a workstation—system 100, by inserting a PCB into an insertion slot of a workstation—system 200, and by replacing the hard drive of a copier with the system 300.

Numerous other embodiments of the invention will be apparent to persons skilled in the art without departing from the spirit and scope of the invention as defined in the appended claims.

What is claimed is:

1. A method comprising:
providing a device comprising a non-volatile memory;
receiving digital data for being stored in the non-volatile memory;
prior to storing the digital data in the non-volatile memory, encoding the digital data using a key stored in a volatile memory that is supplied with power only when the device is in a powered-on condition, the volatile memory for being erased automatically upon interruption of supply of power thereto, the encoding for preventing access to the digital data in a non-encoded form absent the key;
storing the encoded digital data in the non-volatile memory; and,
subsequent to storing the encoded digital data in the non-volatile memory, erasing the key from the volatile memory.

2. A method according to claim 1, wherein erasing the key from the volatile memory is performed in response to one of the device entering a low-power mode, the device being powered-down, elapse of a predetermined time interval during which the device is inactive, and receipt of a command for erasing the key from the volatile memory.

3. A method as defined in claim 1, wherein receiving digital data comprises receiving temporary digital data.

4. A method as defined in claim 3, wherein receiving temporary digital data comprises receiving digital data for storing within the volatile memory pending encoding and storage in the non-volatile memory.

5. A method as defined in claim 3, wherein receiving temporary digital data comprises receiving temporary Internet files.

6. A method as defined in claim 3, wherein receiving temporary digital data comprises receiving temporary digital data allocated to a temporary file directory.

7. A method as defined in claim 1, wherein providing a device comprises providing one of a computer, a printer, a copier, a scanner, a projection display, and a fax machine.

8. A method as defined in claim 1, wherein the volatile memory is erased upon power-down of the device.

9. A method as defined in claim 1, comprising:
retrieving the encoded digital data from the non-volatile memory;
decoding the retrieved encoded digital data using the key stored in the volatile memory; and,
providing the decoded digital data.

10. A method as defined in claim 1, comprising:
generating the key; and,
storing the key in the volatile memory.

11. A method as defined in claim 10, wherein the key is generated using a processor of the device.

12. A method as defined in claim 10, wherein the key is generated using a processor other than a processor of the device and wherein the key is provided to the device subsequent to being generated.

13. A method as defined in claim 10, comprising:
generating a second key; and,
replacing the key stored in the volatile memory with the second key.

14. A method as defined in claim 13, wherein the key is replaced with the second key such that the key is erased.

15. A method as defined in claim 13, wherein the second key is generated after elapse of a predetermined time interval wherein a queue having the encoded data stored therein is empty.

16. A method as defined in claim 13, wherein the second key is generated after elapse of a predetermined time interval.

17. A method as defined in claim 13, wherein the second key is generated after completion of at least one of an application executed on the device and a process completed by the device.

18. A method as defined in claim 13, wherein the second key is generated during a process for switching the device into one of a stand by mode and a hibernation mode.

19. A method as defined in claim 13, wherein the second key is generated during a logoff process.

20. A system comprising:
volatile memory for storing a key therein, the volatile memory for being erased upon interruption of supply of power thereto;
a communication and output port;
circuitry connected to the communication and output port, to the volatile memory and for being connected to non-volatile memory of a device, the circuitry for:
receiving temporary digital data for storage in the non-volatile memory of the device;
encoding the temporary digital data using the key stored in the volatile memory, the encoding for preventing access to the encoded temporary digital data absent the key, the key other than stored within non-volatile memory of the device;
providing the encoded temporary digital data for storage in the non-volatile memory;
retrieving the encoded temporary digital data from the non-volatile memory;
decoding the retrieved encoded temporary digital data using the key stored in the volatile memory; and,
providing the temporary digital data.

21. A system as defined in claim 20, comprising second circuitry connected to the volatile memory, the second circuitry for generating the key.

22. A system as defined in claim 20, wherein the communication and output port comprise one of a universal serial bus port and an advanced technology attachment port.

23. A system as defined in claim 20, comprising non-volatile memory for storing temporary digital data therein.

24. A computer readable storage medium having stored thereon executable commands for execution on a processor, the processor when executing the commands performing:
one of generating a key and receiving a key for use in encoding;
storing the key in volatile memory;
receiving digital data for storage in non-volatile memory of a device;
encoding the digital data using the key stored in the volatile memory, the encoding for preventing access to the encoded digital data in a non-encoded form absent the key, the key other than stored within non-volatile memory of the device;
providing the encoded digital data for storage in the non-volatile memory;
retrieving the encoded digital data from the non-volatile memory;
decoding the retrieved encoded digital data using the key stored in the volatile memory; and,
providing the digital data.

25. A computer readable storage medium as defined in claim 24, wherein the processor when executing the commands performs receiving temporary digital data.

26. A method comprising:
providing a device for processing digital data and comprising a queue, the queue comprising non-volatile memory;
receiving digital data for being stored within the queue and processed by the device;
ciphering the received digital data with a key to provide secure data, the key stored in volatile memory and for being erased when at least one of power is other than provided to the volatile memory and the received digital data has been ciphered;
storing the secure data within the queue;
retrieving the secure data from the queue;
deciphering the secure data using the key stored in volatile memory; and
processing the deciphered secure data.
